(19) United States
(12) Patent Application Publication
(10) Pub. No.: US 2022/0258878 A1
(43) Pub. Date: Aug. 18, 2022

(54) METHOD AND DEVICE FOR ASSISTING AN AIRCRAFT CREW IN RECOVERING THE AIRCRAFT FROM A STALL SITUATION

(71) Applicants: AIRBUS (SAS), Blagnac (FR); AIRBUS OPERATIONS (SAS), TOULOUSE (FR)

(72) Inventors: Julien FONTAN, TOULOUSE (FR); Philippe CASTAIGNS, BLAGNAC CEDEX (FR); Damien LE TINIER, TOULOUSE (FR); Enrique GADEA DIAZ, TOULOUSE (FR)

(21) Appl. No.: 17/674,314

(22) Filed: Feb. 17, 2022

(30) Foreign Application Priority Data
Feb. 18, 2021 (FR) 2101555

(51) Int. Cl. B64D 43/02; G01C 9/06

(52) U.S. Cl. CPC B64D 43/02; G01C 9/06

(57) ABSTRACT

A device including an angle of attack reduction unit is disclosed having a computation unit for computing, after a stall warning has been transmitted and in the event of a lack of response from the crew, a nose down pitch command, and a display unit for displaying, on a vertical display system of the aircraft (AC), an indicator representing the nose down pitch command, a roll control unit including a computation unit for computing a roll command and a display unit for displaying, on a lateral display system of the aircraft (AC). An indicator representing the roll command, and a stabilization unit including a computation unit for computing a nose up pitch command and a display unit for displaying, on the vertical display system, an indicator representing the nose up pitch command, the device assisting the crew of the aircraft (AC) in quickly and efficiently recovering the aircraft (AC) from the stall condition.

### CROSS REFERENCE TO RELATED APPLICATION

This application claims priority to and incorporates by reference the entirety of French Application Number FR 2101555, filed Feb. 18, 2021.

### TECHNICAL FIELD

The present invention relates to a piloting assistance method and device for assisting the crew of an aircraft in recovering from a stall condition.

### PRIOR ART

It is known that the system for commanding and controlling an aircraft, in particular a transport airplane, can, in certain conditions, be moved to a degraded mode, in which various protections of the flight envelope can be lost, such as an angle of attack protection.

In such conditions, the aircraft can approach a stall condition, and without an appropriate response from the crew the aircraft can actually stall, that is it can experience a sudden reduction in its lift, caused by an excessive angle of attack, resulting in a considerable loss of altitude, with a stall generally occurring at low speed.

The common strategies for overcoming stall events or risks are solely based on transmitting a warning indicating a stall condition and, in this case, on the aircraft crew applying the recommended procedure.

For the sake of continuous improvement, aircraft manufacturers consider making improvements to this strategy.

### SUMMARY

The aim of the present invention is to respond to this requirement. To this end, it relates to a piloting assisting method for an aircraft, for assisting the aircraft crew in recovering the aircraft from a stall condition.

According to an exemplary embodiment, the method comprises at least the following steps:
an angle of attack reduction step, implemented by a first angle of attack reduction unit at a predetermined time after a stall warning has been transmitted in the event of a lack of response from the crew, the angle of attack reduction step comprising a computation sub-step involving generating a first nose down target angle of attack and converting this first target angle of attack into a first pitch command, and a display sub-step involving displaying, on at least one vertical display system of the aircraft, at least one first indicator representing the first pitch command;
a stabilization step, implemented by a stabilization unit after the angle of attack reduction step, the stabilization step comprising a computation sub-step involving generating a second nose up target angle of attack and converting this second target angle of attack into a second pitch command, and a second display sub-step involving displaying, on the vertical display system of the aircraft, at least one second indicator representing the second pitch command.

Thus, by virtue of the invention, pilot assistance indicators are determined and displayed, on at least one display system of the aircraft, when the aircraft approaches a stall condition, i.e. after a stall warning has been transmitted followed by a lack of (appropriate) response from the crew. These indicators will assist the crew in recovering the aircraft from the stall in terms of angle of attack, load factor and speed.

Within the scope of the present invention, a “stall condition” is understood to mean either of the following two conditions: a stall risk condition or an actual stall condition, as specified below.

Advantageously, the method further comprises a roll control step, implemented by a roll control unit, with this roll control step comprising a computation sub-step involving converting a target roll angle into a roll command and a display sub-step involving displaying, on at least one lateral display system of the aircraft, at least one indicator representing the roll command, the roll control step being implemented from the moment when the lateral bank angle of the aircraft is greater than a predetermined value and the pitch angle of the aircraft is negative, until the end of the stabilization step. The target roll angle may be substantially equal to 0°.

Furthermore, advantageously, the computation sub-step of the angle of attack reduction step generates the first target angle of attack so as to obtain a predetermined margin in relation to a stall warning angle of attack.

Moreover, advantageously, the computation sub-step of the stabilization step generates the second target angle of attack so as to obtain a flight path angle that is substantially equal to a total flight path angle.

Furthermore, advantageously, the stabilization step:
is implemented as soon as the current angle of attack of the aircraft is lower than a stall warning angle of attack by a predetermined margin; and/or
is terminated (or stopped) when the stall warning is deactivated and the flight path angle of the aircraft is equal to the total flight path angle for a predetermined duration.

Moreover, advantageously, if, when the stabilization step is implemented, the current angle of attack of the aircraft approaches a predetermined additional margin of a stall warning angle of attack, the angle of attack reduction step is implemented again instead of the stabilization step.

The present invention also relates to a piloting assistance device for an aircraft, for assisting the aircraft crew in recovering the aircraft from a stall condition.

According to an exemplary embodiment, the device comprises at least:
an angle of attack reduction unit comprising a computation unit configured to generate, at a predetermined time after a stall warning has been transmitted in the event of a lack of response from the crew, a first nose down target angle of attack and to convert this first target angle of attack into a first pitch command, and a display unit configured to display, on at least one vertical display system of the aircraft, at least one first indicator representing the first pitch command;
a stabilization unit comprising a computation unit configured to generate a second nose up target angle of attack and to convert this second target angle of attack into a second pitch command, and a second display unit configured to display, on the vertical display system of the aircraft, at least one second indicator representing the second pitch command.

Furthermore, advantageously, the device further comprises a roll control unit comprising a computation unit configured to convert a target roll angle into a roll command and a display unit configured to display, on at least one lateral display system of the aircraft, at least one indicator representing the roll command.

### BRIEF DESCRIPTION OF THE FIGURES

The accompanying figures will clearly show how the invention can be implemented. In these figures, identical reference signs designate similar elements.

FIG. 1 is the block diagram of a piloting assistance device for an aircraft intended for assisting in recovering the aircraft from a stall condition.

FIG. 2 is a schematic view of an aircraft flying along a flight path, which figure shows the steps of a piloting assistance method implemented by the piloting assistance device of FIG. 1.

FIGS. 3A to 3D show the display produced on a vertical display system when the piloting assistance method is implemented, respectively at successive stages of an angle of attack reduction step of the piloting assistance method.

FIGS. 3E to 3G show the display produced on the vertical display system when the piloting assistance method is implemented, respectively at successive stages of a stabilization step of the piloting assistance method.

### DETAILED DESCRIPTION

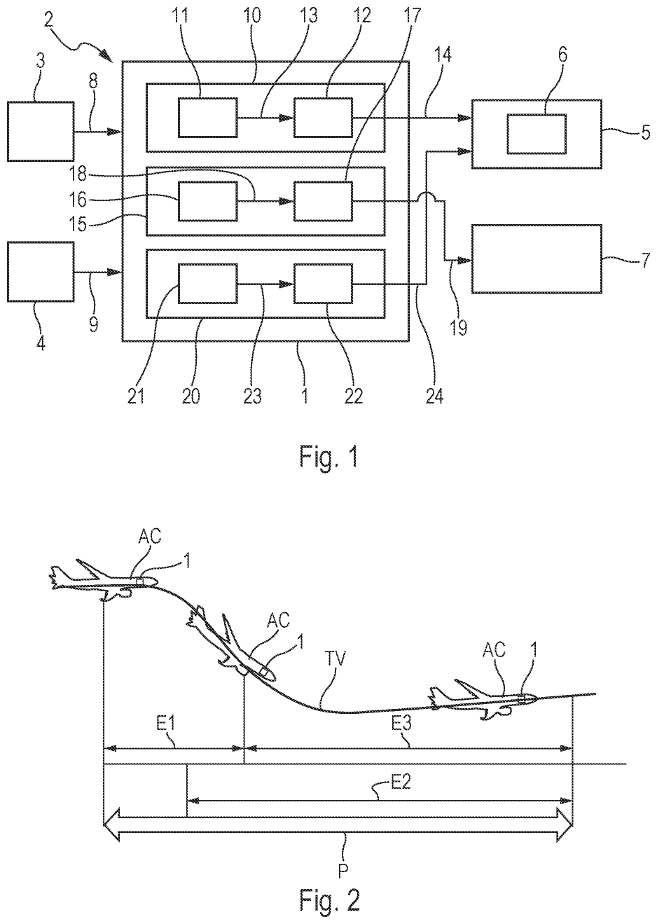

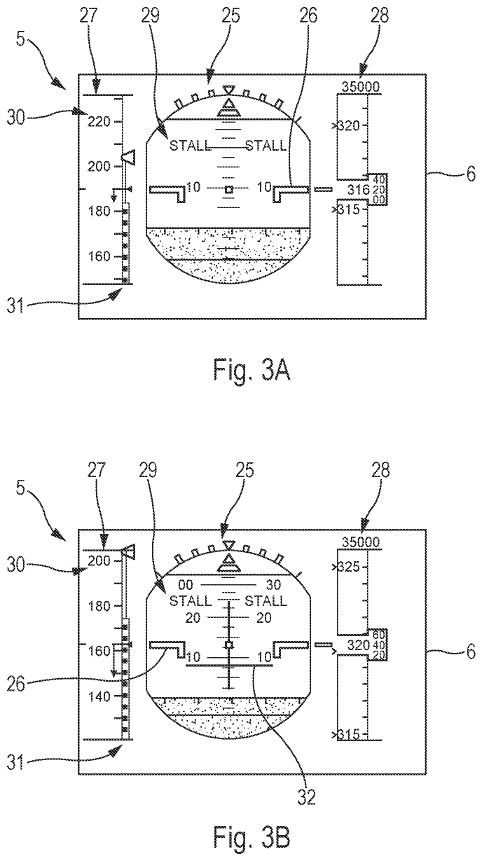

The device 1, shown in FIG. 1 and used to illustrate the invention, is a piloting assistance device for an aircraft AC, in particular a transport airplane, shown in FIG. 2 by way of an example.

This device 1 is intended for assisting the aircraft crew in recovering the aircraft AC from a stall condition. The crew of the aircraft AC is understood to mean the one or more pilot(s) of the aircraft AC, as well as any other person involved in managing the flight of the aircraft AC.

This device 1 can form part of a more general system 2 for presenting data and/or assisting the control and management of the flight of the aircraft AC.

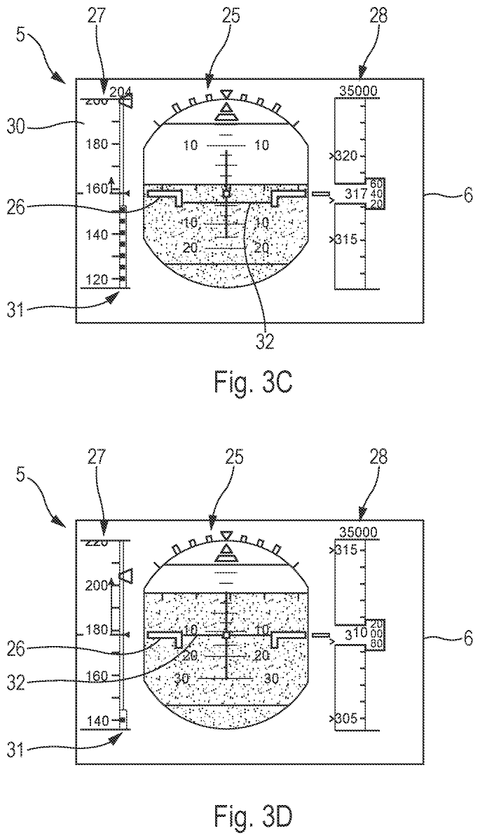

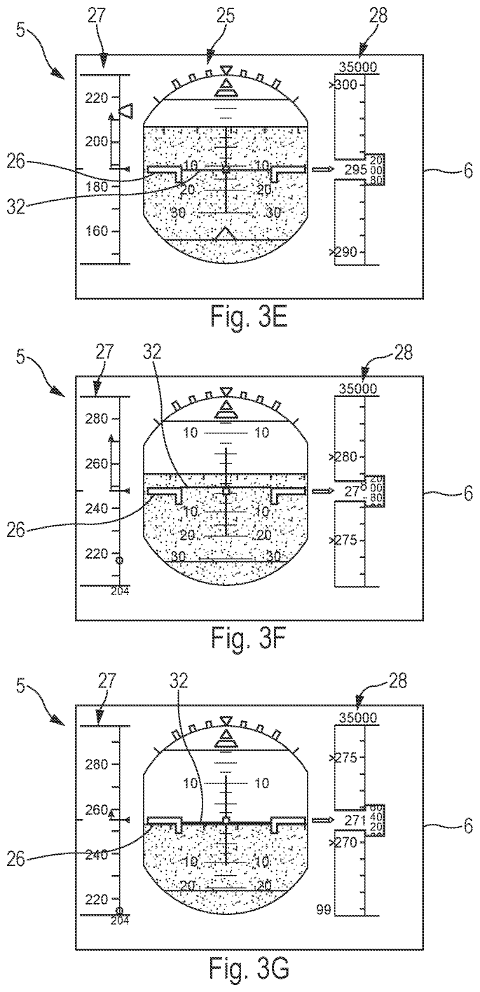

This system 2 particularly comprises, as shown in FIG. 1:
a warning device 3 configured to normally, visually and/or audibly, trigger a stall warning when the conditions for such a trigger are met;
a set 4 of common information sources, comprising sensors and/or various elements or devices capable of determining the current values of parameters of the aircraft AC, such as its speed, its angle of attack, its load factor, etc.;
at least one vertical display system 5. This vertical display system 5 comprises one or more screen(s) 6 capable of displaying the values of current parameters of the aircraft along the vertical axis, as specified hereafter with reference to the screen 6 shown in FIGS. 3A to 3G; and
at least one lateral display system 7. This lateral display system 7 is configured to be able to display the current values of parameters of the aircraft along the lateral axis.

The device 1 is activated after the stall warning (generated by the warning device 3) is triggered, taking into account a predetermined delay time (for example, three seconds) allowing the crew to appropriately respond and so as not to disturb the crew when they correctly respond (according to the appropriate procedure) to this stall warning.

Within the scope of the present invention, a “stall condition” is considered to exist when either of the following two conditions occur: a stall risk condition or an actual stall condition. Indeed, if the crew has not performed a suitable maneuver within the time allowed after the stall warning has been transmitted (or activated), the aircraft can be in a condition in which it is flying beyond the stall warning incidence or in a condition in which the dynamics thereof will take it beyond the stall incidence.

The stall warning is normally triggered by the warning device 3, taking into account the current values of the following parameters of the aircraft:
the angle of attack (AOA), namely the angle formed by the longitudinal axis of the aircraft and by the projection of its speed vector onto a reference plane passing through this longitudinal axis;
the load factor; and
the speed.

The device 1, which is connected by means of links 8 and 9, respectively, to the warning device 3 and to the set 4 comprises, as shown in FIG. 1:
an angle of attack reduction unit 10 comprising a computation unit 11 and a display unit 12. The computation unit 11 is configured to generate, at a predetermined time after a stall warning is transmitted (by the warning device 3) in the event of a lack of response from the crew, a nose down target angle of attack α1c (specified below) and to convert this target angle of attack α1c into a pitch command OT1. The display unit 12 is configured to display at least one indicator 32 (FIGS. 3B to 3D) on the screen 6 of the vertical display system 5 (as shown by a link 14), which indicator represents the pitch command OT1 (received from the computation unit 11 via a link 13);
a roll control unit 15 comprising a computation unit 16 and a display unit 17. The computation unit 16 is configured to convert a predetermined target roll angle ϕc into a roll command OR. The display unit 17 is configured to display at least one indicator (not shown) representing the roll command OR (received from the computation unit 16 via a link 18) on at least one screen (not shown) of the lateral display system 7 (as shown by a link 19); and
a stabilization unit 20 comprising a computation unit 21 and a display unit 22. The computation unit 21 is configured to generate a nose up target angle of attack α2c (specified below) and to convert this target angle of attack α2c into a pitch command OT2. The display unit 22 is configured to display at least one indicator 32 (FIGS. 3F and 3G) representing the pitch command OT2 (received from the computation unit 21 via a link 23) on the screen 6 of the vertical display system 5 (as shown by a link 24).

The device 1, as described above, is able to implement a piloting assistance method P. This piloting assistance method P is intended to assist the crew of the aircraft AC in recovering (if necessary) the aircraft AC from a stall condition.

The method P is shown in FIG. 2. This FIG. 2 shows various positions of the aircraft AC (equipped with the device 1) flying along a flight path TV when the method P is implemented. This FIG. 2 particularly shows the periods when the various steps E1, E2 and E3 (specified below) of this method P are implemented when the aircraft AC is in flight.

The method P is described below, with reference to FIGS. 3A to 3G, which show a particular embodiment of a screen 6 of the vertical display system 5. This screen 6 normally comprises a display window 25 relating to a flight director that displays a symbol 26 in real time indicating the current value of the pitch angle of the aircraft AC. Furthermore, the screen 6 also comprises normal display windows 27 and 28, which respectively display speed and altitude information of the aircraft AC.

The method P firstly comprises an angle of attack reduction step E1. The step E1 is implemented by the angle of attack reduction unit 10 (FIG. 1), if a stall warning is transmitted by the warning device 3 and if there is a lack of an appropriate response from the crew after a predetermined duration (after this transmission). This warning is indicated on the screen 6 by multiple displays, preferably in red, of the word “STALL”, as shown by an arrow 29 in FIG. 3A. The warning is also indicated by an additional indicator 31 on the speed window 27 next to the speed scale 30. This additional indicator 31 comprises, for example, red squares that are arranged at all the speeds of the speed scale 30 that are likely to generate a stall.

The step E1 comprises a computation sub-step (implemented by the computation unit 11) involving generating the nose down target angle of attack α1c, as well as involving converting this target angle of attack α1c in order to obtain the pitch command OT1, and a display sub-step (implemented by the display unit 12) involving displaying at least the indicator 32 representing the pitch command OT1 on the screen 6 of the vertical display system 5, as shown in FIG. 3B.

The computation unit 11 computes, in the computation sub-step of the angle of attack reduction step E1, the target angle of attack α1c so as to obtain a sufficient (predetermined) margin in relation to a stall warning angle of attack, i.e. in relation to the angle of attack for which the stall warning is generated by the warning device 3.

Step E1 (and thus the method P) is therefore triggered after the stall warning has been triggered, with a delay so as not to disturb a crew that has correctly responded to the stall warning.

After the warning is transmitted, as shown in FIG. 3A, triggering the implementation of the method P, the indicator 32 is therefore displayed on the window 25, as shown in FIG. 3B. From this moment, the crew may pilot the aircraft AC manually, in order to bring the current pitch of the aircraft AC to the pitch value indicated by the indicator 32, by making the symbol 26 coincide with this indicator 32, as shown in FIG. 3C.

In the following condition, shown in FIG. 3D, the aircraft AC has recovered the desired attack margin.

The purpose of this step El is to allow the crew to manually fly the aircraft AC in order to apply the pitch command OT1 so that the aircraft AC finds an appropriate angle of attack for which there is no longer a risk of stalling.

The method P also comprises a roll control step E2, implemented by the roll control unit 15. The roll control step E2 comprises a computation sub-step (implemented by the computation unit 16) involving converting the target roll angle ϕc (with a predetermined value) in order to obtain the roll command OR and a display sub-step (implemented by the display unit 17) involving displaying at least one indicator (not shown) representing the roll command OR on the lateral display system 7 (FIG. 1). This roll control step E2 is implemented, after step E1 is triggered, when the aircraft crew has significantly reduced the angle of attack when step E1 is implemented. More specifically, this step E2 starts from the moment when the lateral bank angle of the aircraft AC is greater than a predetermined value and the pitch angle of the aircraft AC is negative.

During step E2, the crew may pilot the aircraft AC manually, in order to bring the current roll of the aircraft AC to the roll value indicated by the indicator (not shown) representing the roll command OR.

This roll control step E2 is implemented until the end of the stabilization step E3 specified below.

The target roll angle ϕc may be substantially equal to 0°. Thus, the purpose of step E2 is to negate any roll of the aircraft AC and to maintain zero roll when the method P is implemented in order to laterally stabilize the aircraft.

The method P also comprise this (vertical) stabilization step E3. The step E3 is implemented by the stabilization unit 20, after the angle of attack reduction step E1. The stabilization step E3 comprises a computation sub-step (implemented by the computation unit 21) involving generating the nose up target angle of attack α2c and converting this target angle of attack α2c in order to obtain the pitch command OT2, and a display sub-step (implemented by the display unit 22) involving displaying at least the indicator 32 representing this pitch command OT2 on the screen 6 of the vertical display system 5, as shown in FIG. 3F.

In the example shown in FIGS. 3B to 3G, the same indicator 32 is provided for displaying the pitch command OT1 in step E1 and for displaying the pitch command OT2 in step E3. It is also possible to contemplate displaying two different indicators (for example, with different shapes, sizes and/or colors) for these two pitch commands OT1 and OT2, respectively.

The computation unit 21 computes, in the computation sub-step of the stabilization step E3, the target angle of attack α2c so as to obtain a flight path angle (FPA) of the aircraft AC that is substantially equal to a total flight path angle.

Furthermore, the stabilization step E3 (i.e. the transition from step E1 to step E3) is implemented as soon as the current angle of attack of the aircraft AC is lower (by a predetermined margin) than the stall warning angle of attack. This transition is shown in FIG. 3E.

As step E3 is implemented after step E1 (angle of attack reduction), the purpose of this step E3 is to generate a nose up pitch command OT2 in order to reduce the loss of altitude of the aircraft AC and to stabilize its airspeed (with the current thrust of the engines of the aircraft AC).

During step E3, the crew may pilot the aircraft AC manually, in order to bring the current pitch of the aircraft AC to the pitch value indicated by the indicator 32, by making the symbol 26 coincide with this indicator 32, as shown in FIG. 3F.

The stabilization step E3 (and thus the method P) is completed, as shown in FIG. 3G, when the following two conditions are simultaneously met:
the stall warning is deactivated; and
the flight path angle of the aircraft is equal to the total flight path angle for a predetermined duration.

Furthermore, if, when the stabilization step E3 is implemented, the current angle of attack of the aircraft AC again approaches (by a predetermined additional margin) the stall warning angle of attack, the angle of attack reduction step E1 is implemented again instead of the stabilization step E3. This allows these steps E1 and E3 to be reversed, and the method P is implemented again, as described above, from this step E1.

Therefore, the transition between steps E1 and E3 is reversible. The reverse transition from step E3 to step E1 is implemented when the current angle of attack comes too close to the stall warning angle of attack, by making provision for hysteresis in relation to the initial transition between steps E1 and E3.

Thus, by virtue of this method P implemented by the device 1, pilot assistance indicators are determined and displayed on the display systems 5 and 7 of the aircraft when the aircraft approaches a stall condition (after the stall warning has been triggered). These indicators will assist the crew in quickly and efficiently recovering from this condition in order to return to a nominal flight condition in terms of angle of attack, load factor and speed, with the aircraft stabilized at the end of the method.

The device 1, as described above, thus has many advantages. Firstly, it increases the awareness of the crew to the stall condition.

In addition, by following the indicators intended to allow recovery from the stall condition, the crew:
prevents the aircraft from actually stalling (and entering a “deep stall” condition);
prevents a second stall condition warning from being triggered during the stall condition recovery phase;
prevents an excessive response that could generate a high overspeed; and
allows the aircraft to reach a stable condition on recovery from the stall condition.

While at least one exemplary embodiment is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A piloting assistance method for an aircraft, for assisting the aircraft crew in recovering the aircraft from a stall condition, the method comprising at least the following steps:
an angle of attack reduction step (E1), implemented by a first angle of attack reduction unit at a predetermined time after a stall warning has been transmitted in the event of a lack of response from the crew, the angle of attack reduction step (E1) comprising a computation sub-step involving generating a first nose down target angle of attack and converting this first target angle of attack into a first pitch command, and a display sub-step involving displaying, on at least one vertical display system of the aircraft (AC), at least one first indicator representing the first pitch command;
a stabilization step (E3), implemented by a stabilization unit after the angle of attack reduction step (E1), the stabilization step (E3) comprising a computation sub-step involving generating a second nose up target angle of attack and converting this second target angle of attack into a second pitch command, and a second display sub-step involving displaying, on the vertical display system of the aircraft (AC), at least one second indicator representing the second pitch command;
a roll control step (E2), implemented by a roll control unit, comprising a computation sub-step involving converting a target roll angle into a roll command and a display sub-step involving displaying, on at least one lateral display system of the aircraft (AC), at least one indicator representing the roll command, the roll control step (E2) being implemented from the moment when the lateral bank angle of the aircraft (AC) is greater than a predetermined value and the pitch angle of the aircraft (AC) is negative, until the end of the stabilization step (E3).

2. The method as claimed in claim 1, wherein the target roll angle is substantially equal to 0°.

3. The method as claimed in claim 1, wherein the computation sub-step of the angle of attack reduction step (El) generates the first target angle of attack so as to obtain a predetermined margin in relation to a stall warning angle of attack.

4. The method as claimed in claim 1, wherein the computation sub-step of the stabilization step (E3) generates the second target angle of attack so as to obtain a flight path angle that is substantially equal to a total flight path angle.

5. The method as claimed in claim 1, wherein the stabilization step (E3) is implemented as soon as the current angle of attack of the aircraft (AC) is lower than a stall warning angle of attack by a predetermined margin.

6. The method as claimed in claim 1, wherein the stabilization step (E3) is completed when the stall warning is deactivated and the flight path angle of the aircraft (AC) is equal to the total flight path angle for a predetermined duration.

7. The method as claimed in claim 1, wherein if, when the stabilization step (E3) is implemented, the current angle of attack of the aircraft (AC) approaches a predetermined additional margin of a stall warning angle of attack, the angle of attack reduction step (E1) is implemented again instead of the stabilization step (E3).

8. A piloting assistance device for an aircraft, for assisting the aircraft crew in recovering the aircraft from a stall condition, the device (1) comprising at least:
an angle of attack reduction unit comprising a computation unit configured to generate, at a predetermined time after a stall warning has been transmitted in the event of a lack of response from the crew, a first nose down target angle of attack and to convert this first target angle of attack into a first pitch command, and a display unit configured to display, on at least one vertical display system of the aircraft (AC), at least one first indicator representing the first pitch command;
a stabilization unit comprising a computation unit configured to generate a second nose up target angle of attack and to convert this second target angle of attack into a second pitch command, and a second display unit configured to display, on the vertical display system of the aircraft (AC), at least one second indicator representing the second pitch command;
a roll control unit comprising a computation unit configured to convert a target roll angle into a roll command and a display unit configured to display, on at least one lateral display system of the aircraft (AC), at least one indicator representing the roll command.
